(19) United States
(12) Patent Application Publication
(10) Pub. No.: US 2026/0323249 A1
(43) Pub. Date: Oct. 15, 2026

(54) PUBLIC SAFETY ACCESS POINT, IP SHORT MESSAGE GATEWAY, USER EQUIPMENT AND METHODS PERFORMED THEREIN

(71) Applicant: Telefonaktiebolaget LM Ericsson (publ), Stockholm (SE)

(72) Inventors: Mats Ola STILLE, BROMMA (SE); George FOTI, DOLLARD DES ORMEAUX (CA); Afshin ABTIN, SOLLENTUNA (SE); Timo FORSMAN, SOLLENTUNA (SE); Jörgen AXELL, DANDERYD (SE); Leif GUSTAVSSON, Stockholm (SE)

(21) Appl. No.: 19/484,812

(22) PCT Filed: May 15, 2024
(86) PCT No.: PCT/EP2024/063417

§ 371 Date: Nov. 14, 2025

Related U.S. Application Data
(60) Provisional application No. 63/502,125, filed on May 15, 2023.
(60) Provisional application No. 63/618,395, filed on Jan. 8, 2024.

(51) Int. Cl. H04W 4/14; H04L 65/1016; H04L 65/1069; H04W 4/90; H04W 88/16

(52) U.S. Cl. CPC H04W 4/14; H04L 65/1016; H04L 65/1069; H04W 4/90; H04W 88/16

(57) ABSTRACT

Embodiments herein relate to, for example, a method performed by a UE (10) for handling messaging of the UE (10) in a communication network. The UE (10) establishes an IMS session targeted to a PSAP; and sends an emergency SMS over the IMS session.

### TECHNICAL FIELD

Embodiments herein relate to a Public Safety Access Point (PSAP) or an IP Short Message Gateway (IP-SM-GW), and a User Equipment (UE) and methods performed therein for communication. Furthermore, a computer program and a computer readable storage medium are also provided herein. In particular, embodiments herein relate to handling messaging such as short message service (SMS) messages of a UE within a communication network.

### BACKGROUND

In a typical communication network, UEs, also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as a radio access node e.g., a Wi-Fi access point or a radio base station (RBS), which in some networks may also be denoted, for example, a NodeB, an eNodeB “, or a gNodeB. A service area or cell area is a geographical area where radio coverage is provided by the radio network node. The radio network node communicates over an air interface operating on radio frequencies with the UE within range of the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High Speed Packet Access (HSPA) for user equipment. In a forum known as the Third Generation Partnership Project (3GPP), telecommunications suppliers propose and agree upon standards for third generation networks, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. This type of connection is sometimes referred to as a backhaul connection. The RNCs and BSCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes which can be connected directly to one or more core networks, i.e., they do not need to be connected to the core via RNCs.

With the emerging 5G technologies such as New Radio (NR), the use of a large number of transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify received signals coming from a selected direction or directions, while suppressing received unwanted signals coming from other directions.

The Internet Protocol (IP) Multimedia Subsystem (IMS) is a well-known Third Generation Partnership Project (3GPP) standard allowing sessions to be set up between two or more parties for a broad variety of services such as voice or video call, interactive messaging sessions or third party specific applications. A few common enablers are defined by 3GPP for common usage among all these services. Examples of such enablers are capability discovery and subscribing to conference events to be used by for example an ad-hoc voice call conference for clients/devices to identify who leaves and enters the conference.

The signalling protocol chosen by 3GPP for IMS is the Session Initiation Protocol (SIP). SIP is an application layer protocol used for controlling multimedia sessions over IP networks. It is a text-based protocol which uses the request/response model. SIP defines messages sent between endpoints, which govern establishment, termination and other essential elements of a multimedia connection. SIP can be used for creating, modifying and terminating sessions consisting of one or more media streams. It can be both unicast and multicast. Examples of applications which SIP may establish, and control are video conferencing, streaming multimedia distribution, instant messaging, presence information, file transfer, fax over IP and online games.

SMS in mobile networks is either carried over non access stratum (NAS), referred to short messaging service (SMS) over NAS and applicable to when a media service center (MSC), a mobility management entity (MME), or an Access and Mobility Management Function (AMF) in different generations of access technology carrier SMS between network (NW) and UE or it is based on SMS over IP, where SMS is carried over SIP and in IMS packet data network (PDN) Connection/protocol data unit (PDU) session.

IMS architecture in general implies that IMS Network Functions are always in home public land mobile network (HPLMN). When a subscriber is roaming, the IMS PDU session will be home routed. All calls and SMS over IP (SMSoIP) will be routed to HPLMN IMS.

When a subscriber is roaming Emergency calls are served by Visited network equipment, both regarding access network and Packet Core as well as IMS.

The solutions for IMS Emergency service have only been covering voice calls and emergency SMS over IP has not been specified.

### SUMMARY

As part of developing embodiments herein, one or more problems were first identified. A problem with the current SMS technology (3GPP TS 24.341 v.17.1.0) is that there is no 3GPP specified emergency SMS service to a local Public Safety Access Point (PSAP). The development of such service will have to include an indication to an inbound roamer whether the visited network supports emergency SMS to local PSAP to make the UE avoid trying if there is no support.

Operators have, however, implemented SMS to a PSAP that works in the HPLMN. Such solution has not been specified, but in principle it means that the SMS to the PSAP is implemented as a normal SMS with the extra functionality that one node in the network needs to change the called emergency number to an identity identifying the PSAP i.e., in normal cases the real telephone number to reach a specific PSAP. If a network has not implemented support for this type of SMS operation and the UE supports the new mechanism, maloperation or misoperation may occur. Likewise, if the UE supports only the old version and the network has implemented support for this type of SMS operation, maloperation can occur.

Thus, an object of embodiments herein is to provide a mechanism for handling SMS messages in a communication network in an efficient manner.

According to an aspect of embodiments herein the object is achieved by providing a method performed by a UE for handling messaging, such as SMS messages, of the UE in a communication network. The UE establishes an IMS session targeted to a PSAP, and sends an emergency SMS over the IMS session.

According to another aspect of embodiments herein the object is achieved by providing a method performed by a PSAP for handling messaging, such as SMS messages, of a UE in a communication network. The PSAP establishes an IMS session for the UE, and receives an emergency SMS over the IMS session.

According to another aspect of embodiments herein the object is achieved by providing a method performed by an IP-SM-GW for handling messaging, such as SMS messages, of a UE in a communication network. The IP-SM-GW establishes an IMS session for the UE and sends an emergency SMS over the IMS session.

According to a further aspect of embodiments herein the object is achieved by providing a UE for handling messaging, such as SMS messages, of the UE in a communication network. The UE is configured to establish an IMS session targeted to a PSAP, and to send an emergency SMS over the IMS session.

According to another aspect of embodiments herein the object is achieved by providing a PSAP for handling messaging, such as SMS messages, of a UE in a communication network. The PSAP is configured to establish an IMS session for the UE, and to receive an emergency SMS over the IMS session.

According to another aspect of embodiments herein the object is achieved by providing an IP-SM-GW for handling messaging, such as SMS messages, of a UE in a communication network. The IP-SM-GW is configured to establish an IMS session for the UE and to send an emergency SMS over the IMS session.

An advantage with embodiments herein is that UEs can avoid submitting an emergency SMS if there is no support for it in the network. This avoids a ‘trial and error’-process. It is also described how the network can base its behaviour on an indication from the UE that the UE supports the new procedures. Thus, embodiments herein handle SMS messages in an efficient manner.

### BRIEF DESCRIPTION OF THE DRAWINGS

Embodiments will now be described in more detail in relation to the enclosed drawings, in which:

FIG. 1a is a schematic overview depicting a communications network according to embodiments herein;

FIG. 1b is a schematic flowchart depicting a method performed by a UE according to embodiments herein;

FIG. 1c is a schematic flowchart depicting a method performed by a PSAP according to embodiments herein;

FIG. 1d is a schematic flowchart depicting a method performed by an IP-SM-GW according to embodiments herein;

FIG. 2 is a schematic signalling scheme according to some embodiments disclosed herein;

FIG. 3a is a schematic flowchart depicting a method performed by a network node according to some embodiments herein;

FIG. 3b is a schematic flowchart depicting a method performed by a radio network node according to some embodiments herein;

FIG. 4 is a schematic flowchart depicting a method performed by a UE according to some embodiments herein;

FIG. 5 is a schematic flowchart depicting a method performed by a second network node according to some embodiments herein;

FIG. 6a is a schematic signalling scheme according to some embodiments herein; is a schematic signalling scheme according to some embodiments herein; FIG. 6b

FIG. 7a is a schematic signalling scheme according to some embodiments herein;

FIG. 7b is a schematic signalling scheme according to some embodiments herein;

FIG. 8a is a schematic overview depicting a network node according to embodiments herein;

FIG. 8b is a schematic overview depicting a radio network node according to embodiments herein;

FIG. 9 is a schematic overview depicting a UE according to embodiments herein;

FIG. 10 is a schematic overview depicting a second network node according to embodiments herein;

FIG. 11 shows an example of a communication system QQ100 in accordance with some embodiments;

FIG. 12 shows a UE QQ200 in accordance with some embodiments;

FIG. 13 shows a network node QQ300 in accordance with some embodiments;

FIG. 14 is a block diagram of a host QQ400, which may be an embodiment of the host QQ116 of FIG. 11, in accordance with various aspects described herein;

FIG. 15 is a block diagram illustrating a virtualization environment QQ500 in which functions implemented by some embodiments may be virtualized;

FIG. 16 shows a communication diagram of a host QQ602 communicating via a network node QQ604 with a UE QQ606 over a partially wireless connection in accordance with some embodiments;

FIG. 17 is a schematic signalling scheme according to some embodiments herein; and

FIG. 18 is a schematic flowchart depicting a flowchart depicting a method according to some embodiments herein.

### DETAILED DESCRIPTION

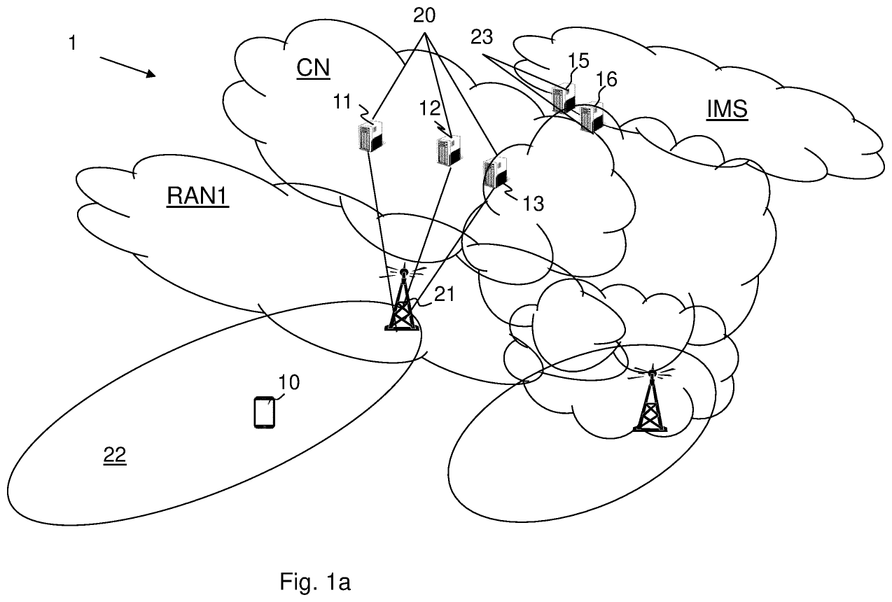

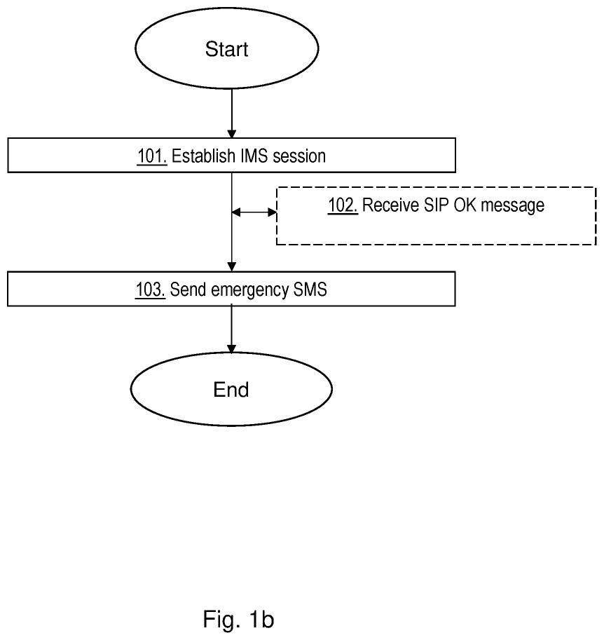

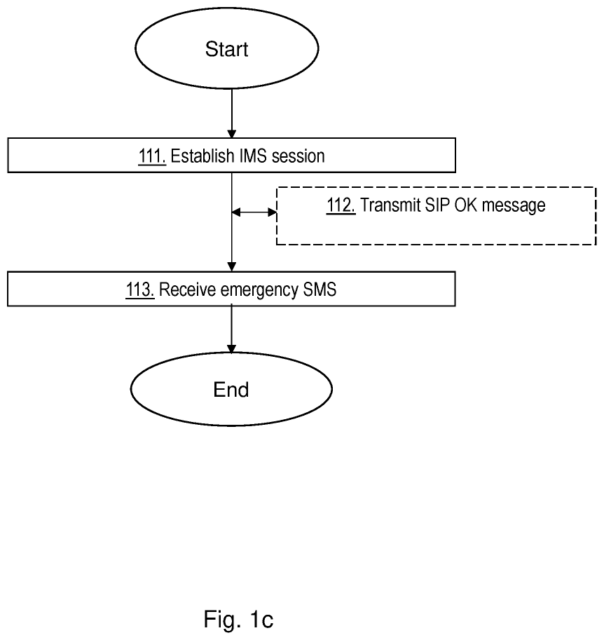

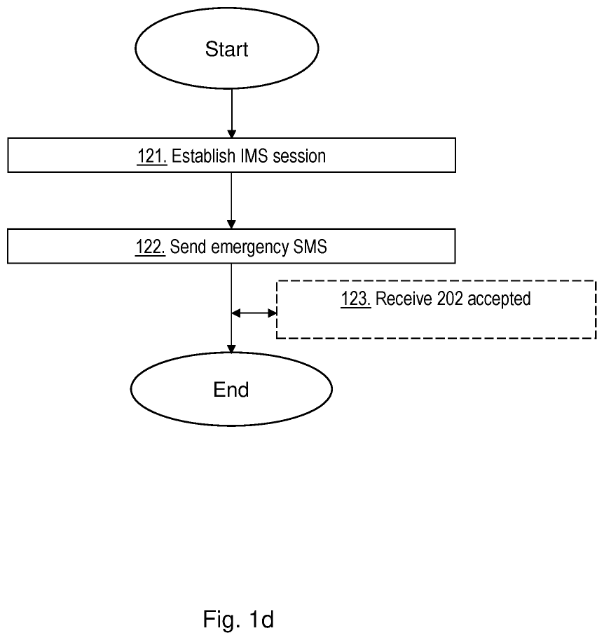

Embodiments herein relate to communication networks in general. FIG. 1a is a schematic overview depicting a communication network 1. The communication network 1 comprises one or more RANs e.g., a first RAN (RAN1), connected to one or more CNs. The communication network 1 may use a number of different technologies, such as Wi-Fi, Long Term Evolution (LTE), LTE-Advanced, NR, 6G, Wideband Code Division Multiple Access (WCDMA), Global System for Mobile communications/Enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, i.e., NR, however, embodiments are applicable also in further development of the existing communication systems such as, e.g., 3G and LTE.

In the communication network 1, UEs, e.g., a UE 10 such as a mobile station, a non-access point (non-AP) STA, a STA, a wireless device and/or a wireless terminal, are connected via the one or more RANs, to the one or more CNs, e.g., comprising CN nodes such as a first core node 11, a second core node 12 and a third core node 13 of the CN. The first/second/third core node may be, e.g., a core network node such as an Access & Mobility Management Function (AMF) node, a user plane function (UPF) node or a session management function (SMF) node for handling mobility and similar matters. It should be understood by those skilled in the art that “UE” is a non-limiting term which means any terminal, wireless communication terminal, user equipment, Machine Type Communication (MTC) device, Internet of Things (IoT) operable device, Device to Device (D2D) terminal, mobile device e.g. smart phone, laptop, mobile phone, sensor, relay, mobile tablets or any device communicating within a cell or service area.

The communication network 1 comprises a radio network node 21, providing radio coverage over a geographical area, a radio coverage area 22, a cell, of a first radio access technology (RAT), such as New Radio (NR), LTE, UMTS, Wi-Fi or similar. The radio network node 21 may be a radio core node such as radio network controller or an access point such as a wireless local area network (WLAN) access point or an Access Point Station (AP STA), an access controller, a base station, e.g. a radio base station such as a NodeB, an evolved Node B (eNB, eNodeB), a gNodeB, a base transceiver station, Access Point Base Station, base station router, a transmission arrangement of a radio base station, a stand-alone access point or any other network unit capable of serving a UE within the service area served by the first radio network node 21 depending e.g. on the first radio access technology and terminology used. The cell may be of a network such as a PLMN and the UE 10 may be visiting the PLMN thus the network may be a visiting PLMN (VPLMN) but may also be a HPLMN.

The communication network 1 provides IMS services, such as voice over LTE (VoLTE), SMS messaging or similar, and comprises IMS nodes such as a first IMS node and a second IMS node 16 of an IMS. The IMS network may comprise a Call Session Control Function (CSCF) node and a Home Subscriber Server (HSS). The first IMS node 15 may be an IP Short Message Gateway (IP-SM-GW), and the second IMS node 16 may be a Call Session Control Function (CSCF) node such as a proxy-CSCF (P-CSCF) node. The Call session control function, e.g., facilitates Session Initiation Protocol (SIP) setup and teardown and the HSS may play the role of a location server in the IMS, in addition to acting as an authentication, authorization, accounting (AAA) server. The CSCF may comprise a number of distributed functions e.g. a P-CSCF, an Interrogating CSCF (I-CSCF) node, and a Serving CSCF (S-CSCF) node. The P-CSCF may act as an entry point in the IMS network.

Embodiments herein enable a network node 20 of a VPLMN or a HLPMN such as the first core node 11 to provide information to enable a visiting UE, or a UE being in a HPLMN, to perform emergency SMS messaging in a VPLMN or a HPLMN. The network node 20 may comprise a packet core node, such as an AMF, a gateway, or similar. Furthermore, a second network node 23 e.g. the first or second IMS node, such as a gateway or an IP-SM-GW, may be comprised in the communication network 1 handling messaging in the communication network.

Embodiments herein may be implemented as physical bare metal, virtual or cloud native such as Kubernetes environment in e.g., Hypercloud networks.

Embodiments herein are compatible with any version of O-RAN implementation.

Thus, inbound UEs such as the UE 10 should only submit emergency SMSoIP when the visited network has indicated that it has the necessary support for the new emergency SMS service procedure. This saves UEs from submitting emergency SMSs that would otherwise be rejected.

Example embodiments of a method performed by the UE 10 for handling messaging, such as SMS messages, of the UE 10 in the communication network will now be described with reference to a flowchart depicted in FIG. 1b. The actions do not have to be taken in the order stated below, but may be taken in any suitable order. Dashed boxes are optional features.

Action 101. The UE 10 establishes an IMS session targeted to a PSAP. The IMS session may be of a special media type such as messaging. The IMS session may be utilized for a special content type such as messaging, as maybe indicated by an XML body. Although the IMS session may be created with a special media such as zero ported audio, it may be subject handling of normal IMS sessions in terms of upgradeability to add additional media such as audio and/or video and/or Message Session Relay protocol (MSRP).

Action 102. The UE 10 may receive a session initiation protocol OK message from the PSAP, accepting the IMS session.

Action 103. The UE 10 sends an emergency SMS over the IMS session.

The IMS session may be torn down after a configurable timer.

Example embodiments of a method performed by the PSAP for handling messaging, such as SMS messages, of the UE 10 in the communication network will now be described with reference to a flowchart depicted in FIG. 1c. The actions do not have to be taken in the order stated below, but may be taken in any suitable order. Dashed boxes are optional features.

Action 111. The PSAP establishes the IMS session for the UE 10. The IMS session may be of a special media type such as messaging. Although the IMS session may be created with a special media for messaging it may be subject handling of normal IMS sessions in terms of upgradeability to add additional media. The IMS session may be utilized for a special content type such as messaging, as maybe indicated by an XML body. Although the IMS session may be created with a special media such as zero ported audio, it may be subject handling of normal IMS sessions in terms of upgradeability to add additional media such as audio and/or video and/or Message Session Relay protocol (MSRP).

Action 112. The PSAP may transmit the session initiation protocol OK message to the UE, accepting the IMS session.

Action 113. The PSAP receives an emergency SMS over the IMS session.

The IMS session may be torn down after a configurable timer.

Example embodiments of a method performed by the IP-SM GW for handling messaging, such as SMS messages, of the UE 10 in the communication network will now be described with reference to a flowchart depicted in FIG. 1d. The actions do not have to be taken in the order stated below, but may be taken in any suitable order. Dashed boxes are optional features.

Action 121. The IP-SM GW establishes an IMS session targeted to a PSAP. The IMS session may be of a special media type such as messaging. Although the IMS session may be created with a special media for messaging it may be subject handling of normal IMS sessions in terms of upgradeability to add additional media. The IMS session may be utilized for a special content type such as messaging, as maybe indicated by an XML body. Although the IMS session may be created with a special media such as zero ported audio, it may be subject handling of normal IMS sessions in terms of upgradeability to add additional media such as audio and/or video and/or Message Session Relay protocol (MSRP).

Action 122. The IP-SM GW sends an emergency SMS over the IMS session.

Action 123. The IP-SM GW may receive a 202 accepted from the PSAP.

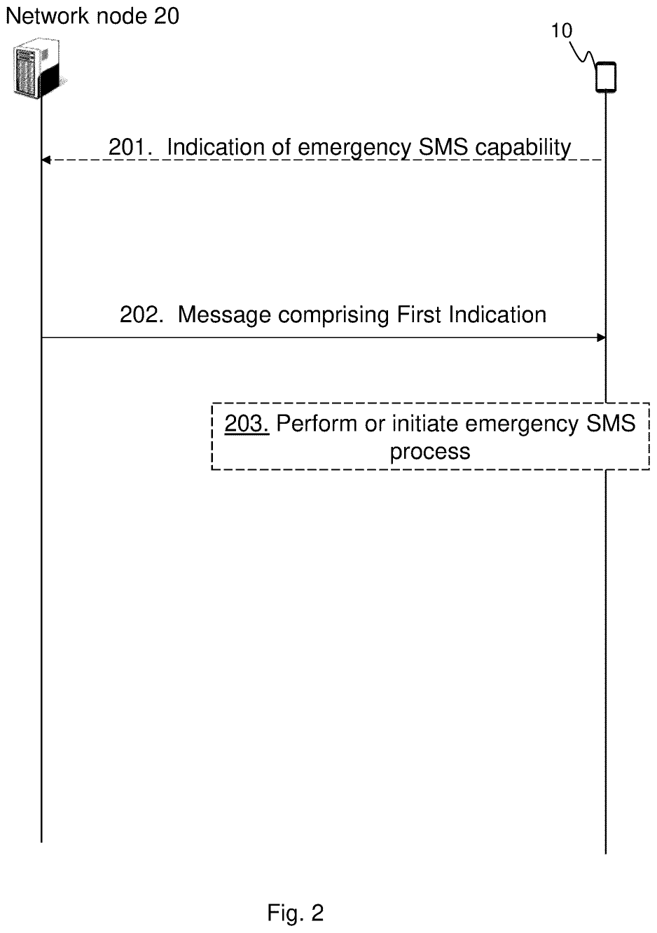

FIG. 2 shows a combined signalling scheme and flowchart according to some examples herein.

Action 201. The UE 10 may transmit an indication such as a value or information indicating emergency SMS capability of the UE 10. For example, that the UE is capable of receiving a message from a network node indicating that the network node supports emergency SMS over IMS in the network. Thus, in order for the network to know whether the UE is emergency SMSoIP capable or not, the UE 10 may include an emergency-sms indication in the SIP REGISTER message during the IMS registration process. For example, the Contact SIP header may contain a media feature tag reflecting the emergency-sms capability.

Action 202. The network node 20, such as a packet core node, transmits to the UE 10, visiting the network or the network being a home network, a message comprising a first indication of network support of emergency SMS over IMS in the network. Thus, the indication sent by the UE 10 may be useful to the network node 20 in order to know whether it is meaningful or not to transmit the message.

Action 203. The UE 10 receiving the message, may perform an action, i.e., acts, based on the indication. The UE 10 may perform or initiate an emergency SMS process based on or taking the first indication into account. The UE 10 may, for example, perform the method described in FIG. 1b. Another example is that the UE 10 may only submit emergency SMSoIP when the visited network, or the home network, has indicated that it has the necessary support for the new emergency SMS service procedure. Thus, avoiding unnecessary transmissions in case the network node does not support the functionality. The UE 10 may initiate an emergency SMS. To enable that, the UE 10 may establish an emergency PDU Session/PDN connection and emergency registers in IMS.

### Some Embodiments are Herein Disclosed

According to an aspect of embodiments herein the object may be achieved by a method performed by a network node, such as an AMF, for handling communication or messaging in a network of a communication network. The network node transmits to a UE, visiting the network or the network being a home network, a message comprising a first indication of network support of emergency SMS over IMS in the network.

According to another aspect of embodiments herein the object may be achieved by a method performed by a radio network node for handling communication or messaging in a network of a communication network. The radio network node transmits to a UE, visiting the network or the network being the home network, system information indicating network support of emergency SMS over IMS in the network.

According to another aspect of embodiments herein the object may be achieved by a method performed by a UE for handling communication or messaging in a network of a communication network. The UE, visiting the network or the network being a home network, receives a message, from a network node such as an AMF, wherein the message comprises a first indication of network support of emergency SMS over IMS in the network.

According to yet another aspect of embodiments herein the object may be achieved by a method performed by a network node for handling communication or messaging in a network of a communication network. The network node maintains a binding for a configurable time between an identity of an originating UE and a PSAP used to deliver an emergency SMS.

It is furthermore provided herein a computer program comprising instructions, which, when executed on at least one processor, cause the at least one processor to carry out any of the methods herein, as performed by the network nodes, the radio network node, and UE, respectively. It is additionally provided herein a computer-readable storage medium, having stored thereon a computer program comprising instructions which, when executed on at least one processor, cause the at least one processor to carry out the methods herein, as performed by the network nodes, the radio network node, and UE, respectively.

According to yet another aspect of embodiments herein the object may be achieved by providing a network node for handling communication or messaging in a network of a communication network. The network node is configured to transmit to a UE, visiting the network or the network being a home network, a message comprising a first indication of network support of emergency SMS over IMS in the network.

According to another aspect of embodiments herein the object may be achieved by a providing a radio network node for handling communication or messaging in a network of a communication network. The radio network node is configured to transmit to a UE, visiting the network or the network being the home network, system information indicating network support of emergency SMS over IMS in the network.

According to still another aspect of embodiments herein the object may be achieved by providing a UE for handling communication or messaging in a network of a communication network. The UE is configured to, when visiting the network or the network being a home network, receive a message, from a network node, wherein the message comprises a first indication of network support of emergency SMS over IMS in the network.

According to yet another aspect of embodiments herein the object may be achieved by providing a network node for handling communication or messaging in a network of a communication network. The network node is configured to maintain a binding for a configurable time between an identity of an originating UE and a PSAP used to deliver an emergency SMS.

Embodiments herein provide a mechanism or mechanisms for SMS over IP. This is generally referred to as “new” mechanisms and procedures, as opposed to legacy mechanisms where the UE is not aware that the recipient of the SMS is an emergency service. In these old systems there is one entity that translates the dialled emergency number to an address (or identity) of a PSAP. It is herein proposed a method used by packet network node such as an AMF to indicate network support of emergency SMS over IMS to the UE. As an example, a network node of a visited PLMN may provide an indication about its support for the new emergency SMS during a 5G Registration over a 3GPP access or non-3GPP access.

An advantage with embodiments herein is that UEs can avoid submitting an emergency SMS if there is no support for it in the network. This avoids a trial&error-process. It is also described how the network can base its behaviour on an indication from the UE that the UE supports the new procedures. Thus, embodiments herein handle SMS messages in an efficient manner.

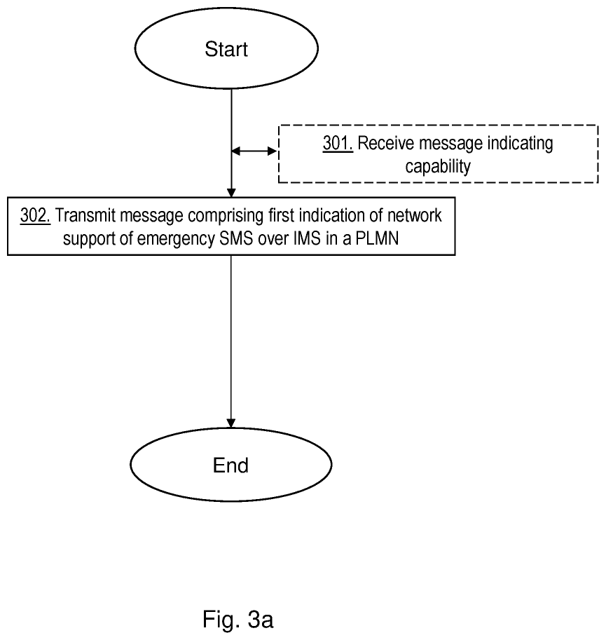

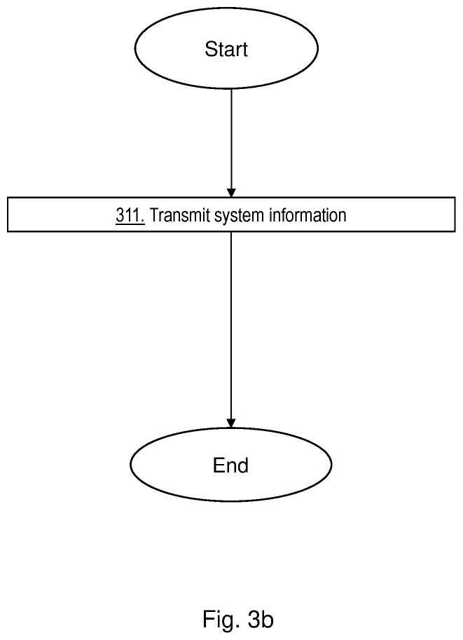

Examples of a method performed by the network node 20, such as a core network node, for example, an AMF, for handling messaging, such as SMS messages, of the UE 10 in a network of the communication network will now be described with reference to a flowchart depicted in FIG. 3a. The actions do not have to be taken in the order stated below, but may be taken in any suitable order. Dashed boxes are optional features.

Action 301. The network node 20 may receive from the UE 10, a message indicating capability such as emergency SMS capability of the UE 10.

Action 302. The network node 20 transmits to the UE 10, visiting the network or the network being the home network, the message comprising the first indication of network support of emergency SMS over IMS in the network, such as the VPLMN or HPLMN. The network node 20 may transmit the first indication of support for Emergency SMS over IMS during a 5G registration/4G Attach/TAU procedure of the UE 10.

Examples of a method performed by the radio network node 21 for handling messaging, such as SMS messages, of the UE 10 in a network of the communication network will now be described with reference to a flowchart depicted in FIG. 3b. The actions do not have to be taken in the order stated below, but may be taken in any suitable order. Dashed boxes are optional features.

Action 311. The radio network node 21 transmits to the UE 10, visiting the network or the network being the home network, system information indicating network support of emergency SMS over IMS in the network, such as the VPLMN or HPLMN. In an example, wherein the UE 10 is in a limited service state such as a UE being outside its home network, outside a roaming partner network of the home network, and/or being unauthenticated, the radio network node 21, may send system information such as a SIB indicating network support of emergency SMS over IMS in the network. The SIB may be a single SIB to convey the fact that RAN supports Emergency SMS over IMS or not, or a SIB indicating that the RAN supports Emergency SMS over IMS and/or NAS.

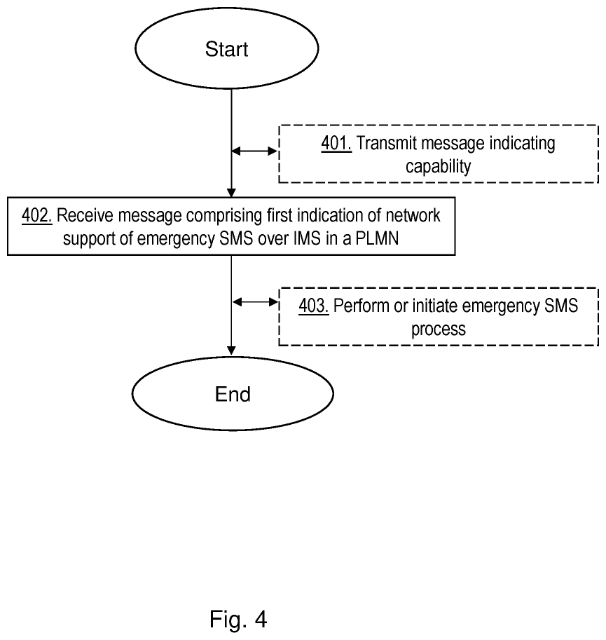

Examples of a method performed by the UE 10 for handling SMS messages of the UE 10 in the communication network will now be described with reference to a flowchart depicted in FIG. 4. The actions do not have to be taken in the order stated below, but may be taken in any suitable order.

Action 401. The UE 10 may transmit a message indicating capability such as emergency SMS capability of the UE.

Action 402. The UE 10, visiting the network or the network being the home network, receives from the network node 20, such as an AMF, the message comprising the first indication of network support of emergency SMS over IMS in the network, such as the VPLMN or the HPLMN.

The UE 10 may receive the first indication of support for Emergency SMS over IMS during a 5G registration/4G Attach/TAU procedure of the UE 10.

In an example, where the UE 10 is in a limited service state such as a UE being outside its home network, outside a roaming partner network of the home network, and/or being unauthenticated, the UE 10 may receive system information such as a SIB indicating network support of emergency SMS over IMS in the network. The SIB may be a single SIB to convey the fact that PLMN supports Emergency SMS over IMS or not, or indicating that the PLMN supports Emergency SMS over IMS and/or NAS.

Action 403. The UE 10 may further perform or initiate an emergency SMS process based on or taking the first indication into account.

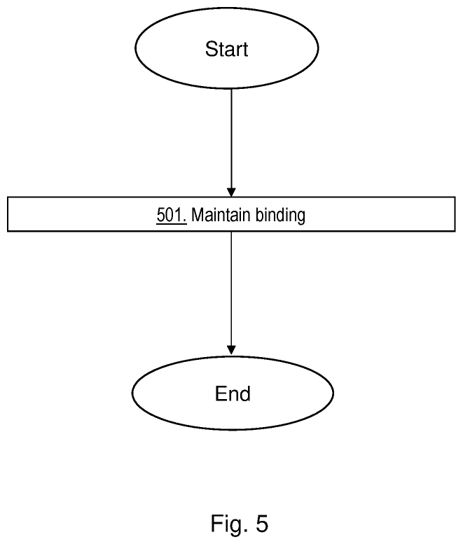

Examples of a method performed by the second network node 23, such as the IMS node or a core network node, for example, an IP-SM-GW, for handling messaging, such as SMS messages, of the UE 10 in the communication network will now be described with reference to a flowchart depicted in FIG. 5. The actions do not have to be taken in the order stated below, but may be taken in any suitable order. Dashed boxes are optional features.

Action 501. The network node 23 maintains a binding for a configurable time between an identity of the originating UE and the PSAP used to deliver the emergency SMS. This enables the second network node 23 to reuse the same PSAP for subsequent emergency SMS messages. The timer may be reset every time an emergency SMS message is received from the identity. The binding may be deleted upon timer expiry.

To ensure that the same initial located PSAP used for the initial SMS sent from the UE 10 is used in subsequent emergency SMSs sent from the UE 10 later, as it is possible that there is more than one PSAP handling a region and it would not be OK if a second emergency SMS from the same UE go to different PSAPs, as this would render difficulty in handling the Emergency SMS over IMS. The following may be proposed:

### Option 1:

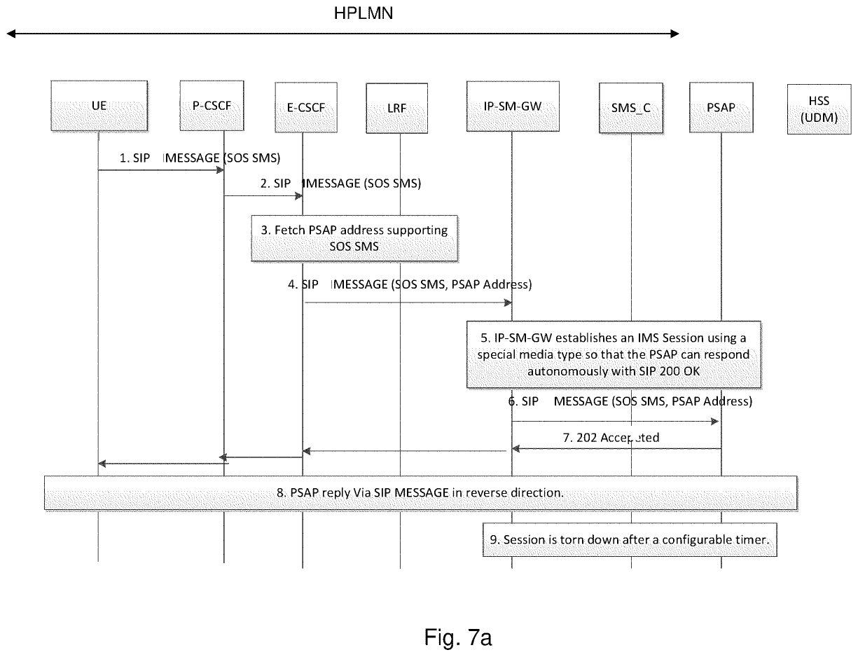

The second network node 23, such as the IP-SM-GW, may establish an emergency IMS session when it receives an initial emergency SMS from the UE 10. The IMS session may include a special media type so that the PSAP can answer autonomously and accept the incoming IMS session. Following the successful establishment of the IMS session, the second network node 23 may send the emergency SMS. Establishing the IMS session ensures that the second network node 23 uses always the same PSAP for that UE 10. The IMS session may be torn down after a configurable timer. (see FIG. 7a).

### Option 2:

The UE 10 may establish an emergency IMS session with the PSAP when transmitting an initial emergency SMS from the UE 10. Thus, instead of the IP-SM-GW establishing the IMS session the UE 10 may establish an IMS session. The IMS session is targeted to the PSAP. (See FIG. 7b).

We refer to 23.167 R4 v. 17.0.0 which shows a solution.

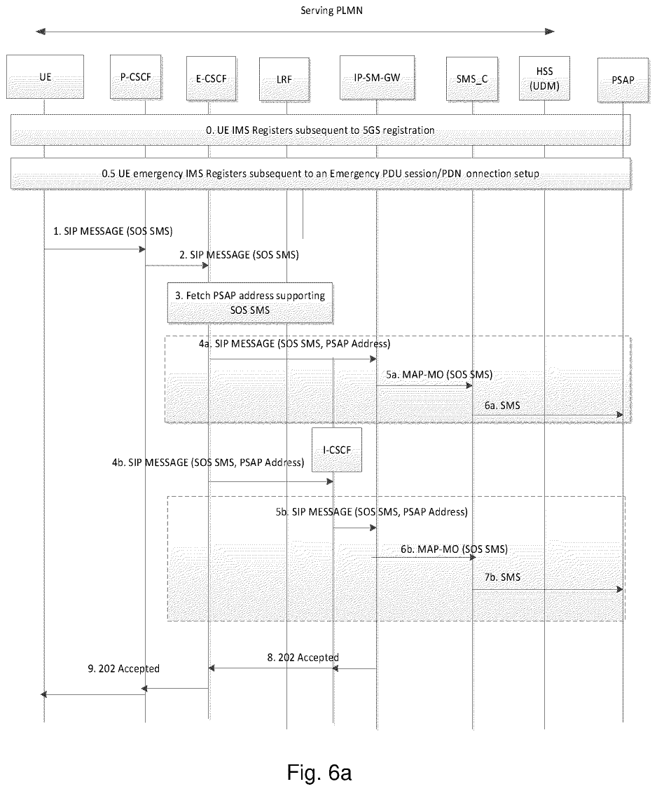

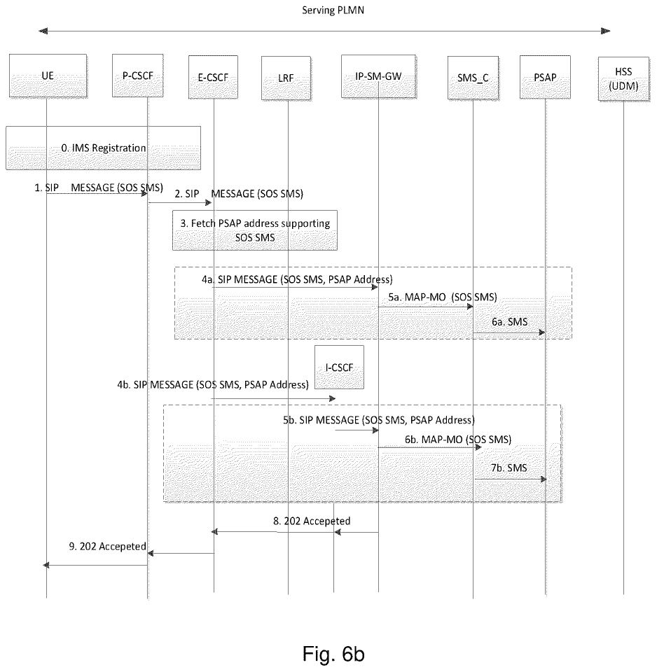

FIG. 6a shows an example of a signalling scheme.
0. UE IMS Registers in action 0 subsequent to a 5G registration and establishing an IMS PDU Session/PDN Connection, All conditions in clause 7. 2 apply for performing this action. The UE receives an indication of support for Emergency SMS over IMS during the 5G registration/4G Attach/TAU procedure. The UE includes an indication that it is Emergency SMS over IMS capable in the IMS registration.
0.5 The user initiates an emergency SMS. To enable that, the UE establishes an emergency PDU Session/PDN connection and emergency registers in IMS.
1. The UE sends to the P-CSCF a SIP MESSAGE for an SOS URN or emergency number including the end user SOS SMS.
2. P-CSCF forwards the SIP MESSAGE to an E-CSCF.
3. E-CSCF Queries the LRF to locate a PSAP that handles emergency SMS over IMS.

One of the two options below can be selected: option a (actions 4a-6a) or option b (actions 4b-7b).
4a. E-CSCF includes the PSAP address in the SIP MESSAGE and forwards it to the IP-SM-GW configured in the E-CSCF.
5a. IP-SM-GW forwards a MAP-MO message to the SMS-C for the PSAP address including the user SOS SMS. The IP-SM-GW maintains a binding for a configurable time between an IP Multimedia Public Identity (IMPU) of the originating UE and the PSAP address used to deliver the initial emergency SMS. This enables the IP-SM-GW to reuse the same PSAP address for subsequent emergency SMS messages for the same type of emergency services. The timer is reset every time an emergency SMS message is received from the IMPU. The binding is deleted upon timer expiry.

NOTE X: It is out of scope if the same agent in the PSAP receives all subsequent SMSs from a single UE.
6a. SMS-C sends the SMS to the local PSAP.
4b. E-CSCF includes the PSAP address in the SIP MESSAGE and forwards it to the I-CSCF configured in the E-CSCF.
5b. I-CSCF forwards the SIP MESSAGE to the IP-SM-GW. I-CSCF may interrogate HSS if it needs to resolve the address of the IP-SM-GW
6b. IP-SM-GW forwards a MAP-MO message to the SMS-C for the PSAP address including the user SOS SMS.
7b. SMS-C sends the SMS to the local PSAP.
8. 202 Accepted is returned to the E-CSCF.
9. 202 is send back to the UE.

PSAP can send a reply back SMS destined for the originating IMPU. SMS messages from the PSAP follow the normal route for delivery of an SMS Message.

FIG. 6b shows signalling scheme according to an example. Inbound roamer that can't be successfully authenticated in IMS are handled similar to handling of roaming users initiating IMS emergency sessions in deployments without IMS-level roaming interfaces as specified in Annex.

The two options are depicted in actions 5a-6a or actions 5b-7b FIG. 6b. The rest of the call flow is identical to the actions in FIG. 6a.

To ensure that the same initial located PSAP used for the initial SMS sent from the UE is used in subsequent SOS SMSs sent from the UE later, as it is possible that there is more than one PSAP handling a region and it would not be OK if a second SOS SMS from the same UE go to different PSAPs, as this would render difficulty in handling the Emergency SMS over IMS. The following is proposed.

### Option 1:

The IP-SM-GW establishes an emergency IMS session when it receives the initial SOS SMS from the UE. The IMS session may include a special media type so that the PSAP can answer autonomously and accept the incoming IMS session. Following the successful establishment of the IMS session, the IP-SM-GW sends the UE SOS SMS. Establishing the IMS session ensures that the IP-SM-GW uses always the same PSAP for that UE. The IMS session may be torn down after a configurable timer.

This is illustrated in FIG. 7a:

The actions are explained in the CR on 23.167 R3 and won't be repeated. The additional actions not covered in 23.167 are explained above and in the Figure as well.
1. The UE sends to the P-CSCF a SIP MESSAGE for an SOS URN or emergency number including the end user SOS SMS.
2. P-CSCF forwards the SIP MESSAGE to an E-CSCF.
3. E-CSCF Queries the LRF to locate a PSAP that handles emergency SMS over IMS.
4. E-CSCF includes the PSAP address in the SIP MESSAGE and forwards it to the IP-SM-GW configured in the E-CSCF.
5. IP-SM-GW establishes the IMS session using a special media type so that the PSAP can respond autonomously with SIP 200 OK.
6. IP-SM-GW sends the SIP MESSAGE including SOS SMS and PSAP address.
7. PSAP accepts with a 202 accepted that is forwarded back to the UE.
8. PSAP replies via SIP message in reverse direction.
9. Session may be torn down after a configurable timer.

### Option 2:

According to embodiments herein, instead of the IP-SM-GW establishing the IMS session the UE establishes an IMS session. The IMS session is targeted to the PSAP, see FIG. 7b.

The same principles of option 1 apply as well to option 2 when it comes to the IMS session. I.e. within the session the UE and PSAP can exchange text carried for example by SIP signals such as SIP MESSAGE or SIP INFO, or as media such as Message Session Relay protocol (MSRP), see RFC 4975.

For handling of unauthenticated UEs, the discovery aspects are the only difference, and they are as depicted above.
1. The UE sends to the P-CSCF a SIP INVITE.
2. E-CSCF fetch PSAP address supporting SOS SMS.
3. E-CSCF sends SIP INVITE to PSAP. The PSAP confirms with SIP 200 OK.
4. The UE transmits SIP message with SOS SMS.
5. E-CSCF sends SIP message with SOS SMS and PSAP address
7. PSAP accepts with a 202 accepted that is forwarded back to the UE.
8. PSAP replies via SIP message in reverse direction.
9. Session may be torn down.

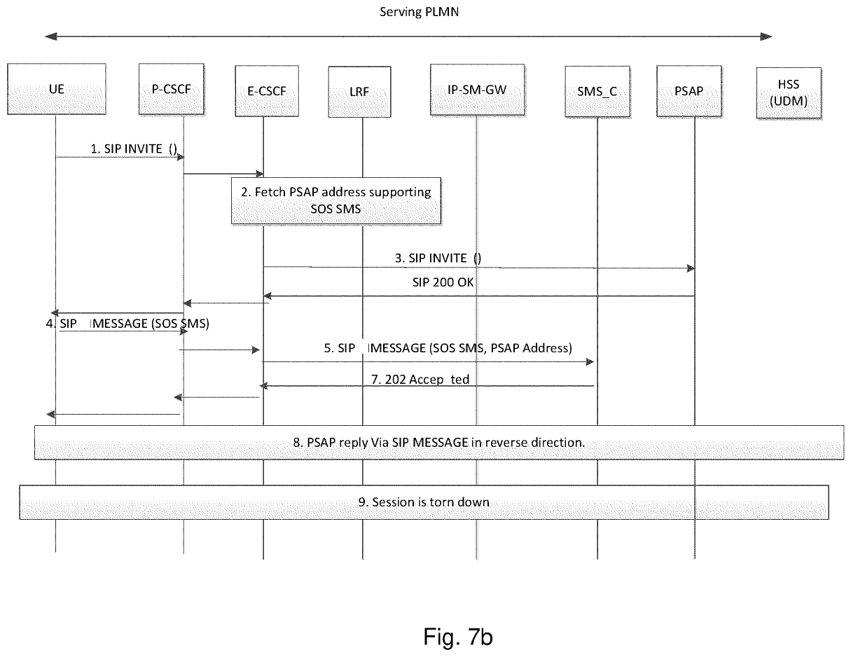

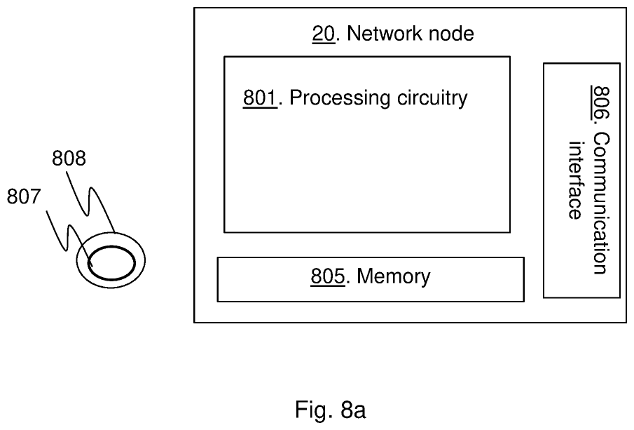

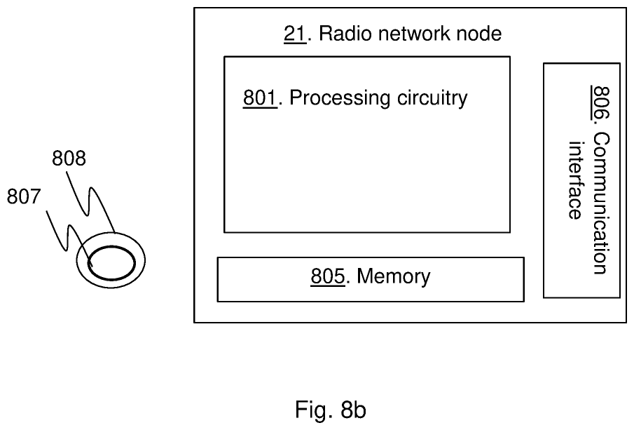

FIG. 8a is a block diagram depicting the network node 20 for handling messaging, such as SMS messages, of the UE 10 in the communication network.

The network node 20 may comprise processing circuitry 801, e.g. one or more processors, configured to perform the methods herein.

The network node may be a PSAP for handling messaging, such as SMS messages, of the UE 10 in the communication network-The PSAP is configured to establish the IMS session for the UE 10. The PSAP is configured to receive the emergency SMS over the IMS session.

The PSAP may be configured to transmit the session initiation protocol OK message to the UE, accepting the IMS session.

The IMS session may be torn down after a configurable timer.

The network node 20 may comprise a core network node such as a packet core node or a NF node such as an AMF.

The network node 20 and/or the processing circuitry 801 may be configured to receive from the UE 10, the message indicating indicating emergency SMS capability of the UE.

The network node 20 and/or the processing circuitry 801 is configured to transmit to the UE 10, visiting the network or the network being the home network, the message comprising the first indication of network support of emergency SMS over IMS in the network, such as the VPLMN or HPLMN. The network node 20 and/or the processing circuitry 801 may be configured to transmit the first indication of support for Emergency SMS over IMS during a 5G registration/4G Attach/TAU procedure of the UE 10.

The network node 20 further comprises a memory 805. The memory 805 comprises one or more units to be used to store data on, such as indication information, emergency SMS over IMS information, subscription, input/output data, metadata, etc. and applications to perform the methods disclosed herein when being executed, and similar. The network node 20 may further comprise a communication interface 806 comprising e.g. one or more antenna or antenna elements.

Thus, it is herein provided the network node 20 for handling communication in a wireless communication network, wherein the network node 20 comprises processing circuitry and a memory, said memory comprising instructions executable by said processing circuitry whereby said network node 20 is operative to perform any of the methods herein.

The methods according to the embodiments described herein for the network node 20 are respectively implemented by means of e.g. a computer program product 807 or a computer program, comprising instructions, i.e., software code portions, which, when executed on at least one processor, cause the at least one processor to carry out the actions described herein, as performed by the network node 20. The computer program product 807 may be stored on a computer-readable storage medium 808, e.g. a disc, a universal serial bus (USB) stick or similar. The computer-readable storage medium 808, having stored thereon the computer program product, may comprise the instructions which, when executed on at least one processor, cause the at least one processor to carry out the actions described herein, as performed by the network node 20. In some embodiments, the computer-readable storage medium may be a transitory or a non-transitory computer-readable storage medium.

FIG. 8b is a block diagram depicting the radio network node 21 for handling messaging, such as SMS messages, of the UE 10 in the communication network.

The radio network node 21 may comprise processing circuitry 811, e.g. one or more processors, configured to perform the methods herein.

The radio network node 21 and/or the processing circuitry 811 is configured to transmit to the UE 10, visiting the network or the network being the home network, the system information indicating network support of emergency SMS over IMS in the network, such as the VPLMN or HPLMN. In an example, wherein the UE 10 is in a limited service state such as a UE being outside its home network or being unauthenticated, the radio network node 21 and/or the processing circuitry 811 may be configured to send system information such as a SIB indicating network support of emergency SMS over IMS in the network. The SIB may be a single SIB to convey the fact that RAN supports Emergency SMS over IMS or not, or a SIB indicating that the RAN supports Emergency SMS over IMS and/or NAS.

The radio network node 21 further comprises a memory 815. The memory 815 comprises one or more units to be used to store data on, such as indication information, emergency SMS over IMS information, subscription, input/output data, metadata, etc. and applications to perform the methods disclosed herein when being executed, and similar. The network node 20 may further comprise a communication interface 816 comprising e.g. one or more antenna or antenna elements.

Thus, it is herein provided the radio network node 21 for handling communication in a wireless communication network, wherein the radio network node 21 comprises processing circuitry and a memory, said memory comprising instructions executable by said processing circuitry whereby said radio network node 21 is operative to perform any of the methods herein.

The methods according to the embodiments described herein for the radio network node 21 are respectively implemented by means of e.g. a computer program product 817 or a computer program, comprising instructions, i.e., software code portions, which, when executed on at least one processor, cause the at least one processor to carry out the actions described herein, as performed by the radio network node 21. The computer program product 817 may be stored on a computer-readable storage medium 818, e.g. a disc, a universal serial bus (USB) stick or similar. The computer-readable storage medium 818, having stored thereon the computer program product, may comprise the instructions which, when executed on at least one processor, cause the at least one processor to carry out the actions described herein, as performed by the radio network node 21. In some embodiments, the computer-readable storage medium may be a transitory or a non-transitory computer-readable storage medium.

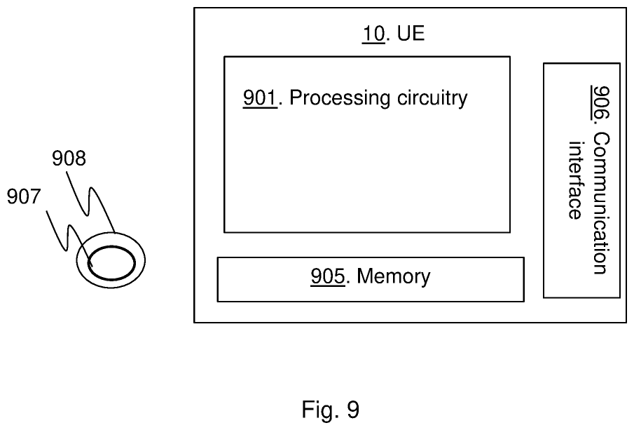

FIG. 9 is a block diagram depicting the UE 10 for handling messaging, such as SMS messages, of the UE 10 in the communication network 1.

The UE 10 may comprise processing circuitry 901, e.g. one or more processors, configured to perform the methods herein.

The UE 10 is configured to establish the IMS session targeted to the PSAP.

The UE 10 is configured to send the emergency SMS over the IMS session.

The UE 10 may be configured to receive the session initiation protocol OK message from the PSAP, accepting the IMS session.

The IMS session may be torn down after a configurable timer

The UE 10 and/or the processing circuitry 901 may be configured to transmit the message indicating emergency SMS capability of the UE.

The UE 10 and/or the processing circuitry 901 is configured to, when visiting the network or being in the home network, receive from the network node 20, such as an AMF, the message comprising the first indication of network support of emergency SMS over IMS in the network, such as the VPLMN or the HPLMN.

The UE 10 and/or the processing circuitry 901 may be configured to receive the first indication of support for Emergency SMS over IMS during a 5G registration/4G Attach/TAU procedure of the UE 10. In an example, where the UE 10 is in a limited service state such as a UE being outside its home network and/or being unauthenticated, the UE 10 and/or the processing circuitry 901 may be configured to receive system information from the radio network node 12 such as a SIB indicating network support of emergency SMS over IMS in the network. The SIB may be a single SIB to convey the fact that RAN supports Emergency SMS over IMS or not, or indicating that the PLMN supports Emergency SMS over IMS and/or NAS.

The UE 10 and/or the processing circuitry 901 may be configured to perform or initiate the emergency SMS process based on the first indication or taking the first indication into account.

The UE may have an upgraded software SW that understands the indication about emergency SMS in the message from the network node.

The UE 10 further comprises a memory 905. The memory 905 comprises one or more units to be used to store data on, such as indication information, private identifiers, SCs, subscription, input/output data, metadata, etc. and applications to perform the methods disclosed herein when being executed, and similar. The UE may further comprise a communication interface 906 comprising e.g. one or more antenna or antenna elements.

Thus, it is herein provided the UE 10 for handling communication in a wireless communication network, wherein the UE 10 comprises processing circuitry and a memory, said memory comprising instructions executable by said processing circuitry whereby said UE 10 is operative to perform any of the methods herein.

The methods according to the embodiments described herein for the UE 10 are respectively implemented by means of e.g. a computer program product 907 or a computer program, comprising instructions, i.e., software code portions, which, when executed on at least one processor, cause the at least one processor to carry out the actions described herein, as performed by the UE 10. The computer program product 907 may be stored on a computer-readable storage medium 908, e.g. a disc, a universal serial bus (USB) stick or similar. The computer-readable storage medium 908, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

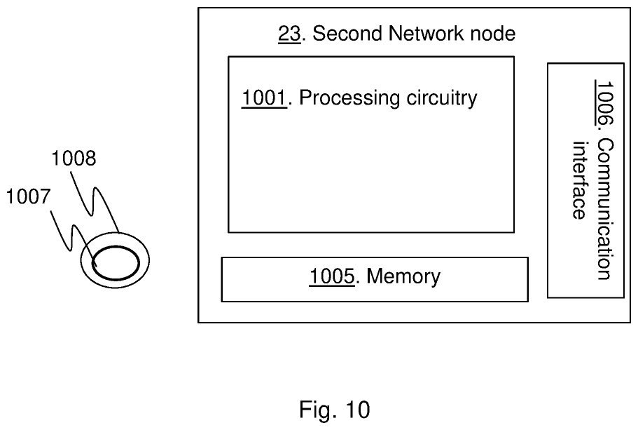

FIG. 10 is a block diagram depicting the second network node 23 for handling messaging, such as SMS messages, of the UE 10 in the communication network.

The second network node 23 may comprise processing circuitry 1001, e.g. one or more processors, configured to perform the methods herein.

The second network node 23 may comprise an IMS node or a core network node.

The second network node 23 may be an IP-SM-GW for handling messaging, such as SMS messages, of the UE 10 in the communication network

The IP-SM GW is configured to establish an IMS session targeted to a PSAP. The IMS session may be of a special media type such as messaging.

The IP-SM GW is configured to send an emergency SMS over the IMS session.

The IP-SM GW may be configured to receive a 202 accepted from the PSAP.

The second network node 23 and/or the processing circuitry 1001 may be configured to maintain a binding for a configurable time between an identity of the originating UE and the PSAP used to deliver the emergency SMS. This enables the second network node 23 to reuse the same PSAP for subsequent emergency SMS messages. The timer may be reset every time an emergency SMS message is received from the identity. The binding may be deleted upon timer expiry.

The second network node 23 further comprises a memory 1005. The memory 1005 comprises one or more units to be used to store data on, such as indication information, ESCs, SCs, subscription, input/output data, metadata, etc. and applications to perform the methods disclosed herein when being executed, and similar. The second network node 23 may further comprise a communication interface 1006 comprising e.g. one or more antenna or antenna elements.

Thus, it is herein provided the second network node 23 for handling communication in a wireless communication network, wherein the second network node 23 comprises processing circuitry and a memory, said memory comprising instructions executable by said processing circuitry whereby said second network node 23 is operative to perform any of the methods herein.

The methods according to the embodiments described herein for the second network node 23 are respectively implemented by means of e.g. a computer program product 1007 or a computer program, comprising instructions, i.e., software code portions, which, when executed on at least one processor, cause the at least one processor to carry out the actions described herein, as performed by the second network node 23. The computer program product 1007 may be stored on a computer-readable storage medium 1008, e.g. a disc, a universal serial bus (USB) stick or similar. The computer-readable storage medium 1008, having stored thereon the computer program product, may comprise the instructions which, when executed on at least one processor, cause the at least one processor to carry out the actions described herein, as performed by the second network node 23. In some embodiments, the computer-readable storage medium may be a transitory or a non-transitory computer-readable storage medium.

In some embodiments a more general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any radio access technology (RAT) or multi-RAT systems, where the devices receives and/or transmit signals, e.g. data, such as New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a radio network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications receivers will appreciate the cost, performance, and maintenance trade-offs inherent in these design choices.

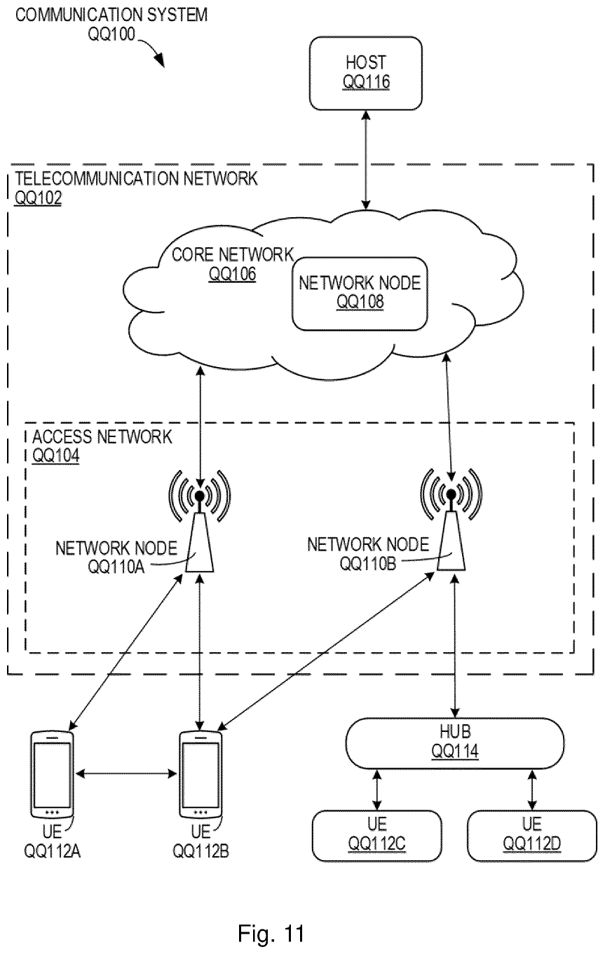

FIG. 11 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110) being examples of the first radio network node 12 and second radio network node 13, or any other similar 3rd Generation Partnership Project (3GPP) access nodes or non-3GPP access points. Moreover, as will be appreciated by those of skill in the art, a network node, being examples of the entities herein, is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of the user equipment (UE) 10, such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) such as network node 15 that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

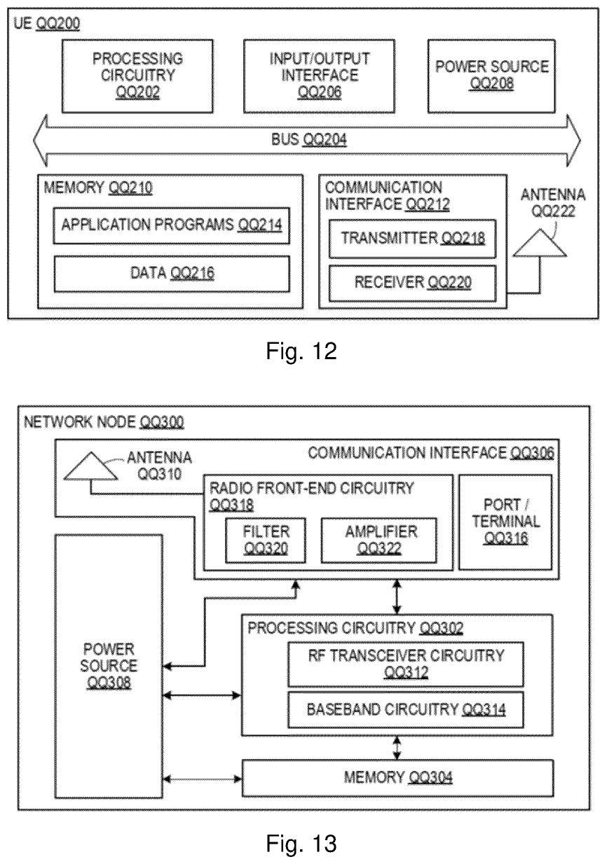

FIG. 12 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signalling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 13 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

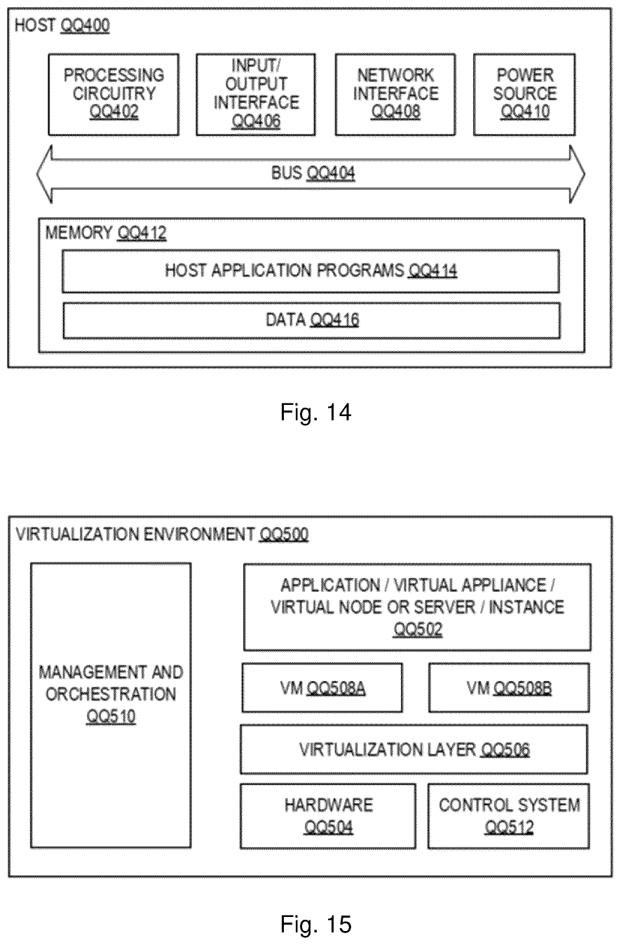

FIG. 14 is a block diagram of a host QQ400, which may be an embodiment of the host QQ116 of FIG. 11, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 12 and 13, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system QQ512 which may alternatively be used for communication between hardware nodes and radio units.

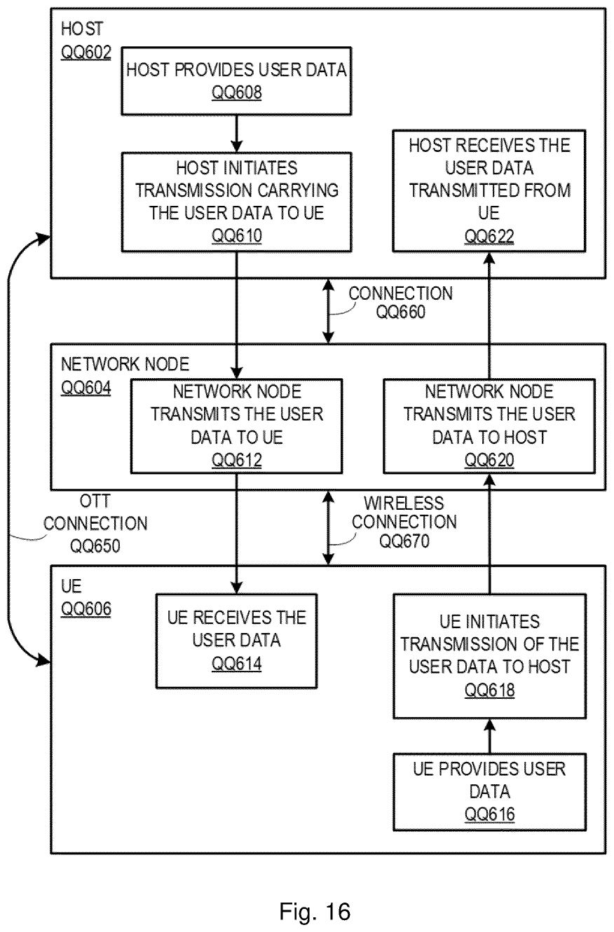

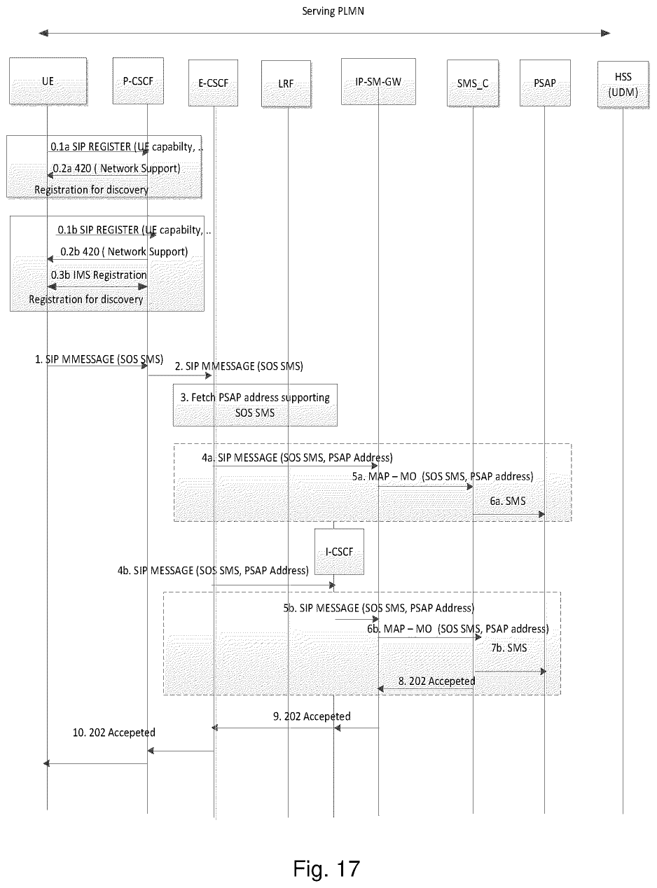

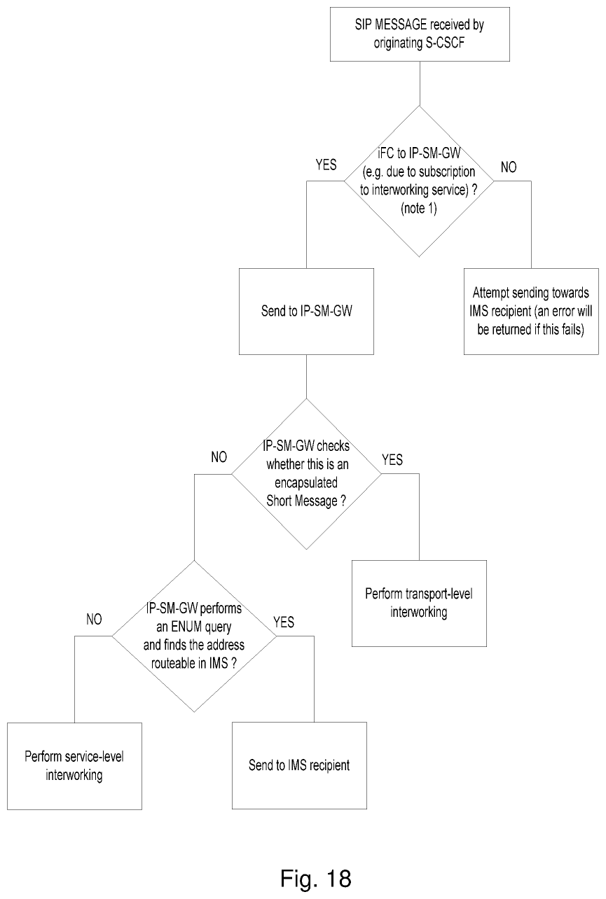

FIG. 16 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 11 and/or UE QQ200 of FIG. 12), network node (such as network node QQ110a of FIG. 11 and/or network node QQ300 of FIG. 13), and host (such as host QQ116 of FIG. 11 and/or host QQ400 of FIG. 14) discussed in the preceding paragraphs will now be described with reference to FIG. 16.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 11) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may handle emergency SMS in an efficient manner and thereby provide benefits such as reduced user waiting time, better responsiveness, and/or extended battery lifetime.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signalling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Embodiment A1

A method performed by a network node for handling messaging, such as SMS messages, of a UE in a communication network, the method comprising
transmitting to the UE, when UE visiting a network of the network node or being in a home network, a message comprising a first indication of network support of emergency SMS over IMS in the network.

### Embodiment A2

The method according to embodiment A1, further comprising
receiving from the UE, an indication indicating capability of receiving the message.

### Embodiment A3

The method according to any of the embodiments A1-A2, wherein the network node comprises a core network node.

### Embodiment B1

A method performed by a UE for handling messaging, such as SMS messages, of the UE in a communication network, the method comprising:
receiving from a network node, when the UE visits a network or being in a home network of the network node, a message comprising a first indication of network support of emergency SMS over IMS in the network.

### Embodiment B2

The method according to embodiment B1, further comprising:
transmitting to the network node, an indication indicating capability of receiving the message a message indicating a request to establish/access the communication network.

### Embodiment B3

The method according to any of the embodiments B1-B2, further comprising:

performing or initiating an emergency SMS process based on, or by taking into account, the first indication and/or the one or more second indications.

### Embodiment C1

A network node for handling messaging, such as SMS messages, of a UE in a communication network, wherein the network node is configured to:
transmit to the UE, visiting a network of the network node or being in a home network, a message comprising a first indication of network support of emergency SMS over IMS in the network.

### Embodiment D1

A UE for handling messaging, such as SMS messages, of the UE in a communication network, wherein the UE is configured to:
receive from a network node, when the UE visits a network of the network node or being in a home network, a message comprising a first indication of network support of emergency SMS over IMS in the network

### Embodiment E1

A method performed by a network node for handling messaging in a network of a communication network, the method comprising:
maintaining a binding for a configurable time between an identity of an originating UE and a PSAP used to deliver an emergency SMS.

### Embodiment F1

A network node for handling messaging in a network of a communication network,
wherein the network node is configured to:
maintain a binding for a configurable time between an identity of an originating UE and a PSAP used to deliver an emergency SMS.

### Embodiment G1

A method performed by a radio network node for handling communication or messaging in a network of a communication network, the method comprising
transmitting to a UE, visiting the network or the network being the home network, system information indicating network support of emergency SMS over IMS in the network.

### Embodiment H1

A radio network node for handling communication or messaging in a network of a communication network, wherein the radio network node is configured to transmit to a UE, visiting the network or the network being the home network, system information indicating network support of emergency SMS over IMS in the network.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1. A method performed by a user equipment, UE, for handling messaging of the UE in a communication network, the method comprising:
establishing an Internet Protocol Multimedia Subsystem, IMS, session targeted to a Public Safety Access Point, PSAP; and
sending an emergency SMS over the IMS session.

2. The method according to claim 1, further comprising
receiving a session initiation protocol OK message from the PSAP, accepting the IMS session.

3. A method performed by a Public Safety Access Point, PSAP, for handling messaging of a user equipment, UE, in a communication network, the method comprising:
establishing an Internet Protocol Multimedia Subsystem, IMS, session for the UE; and
receiving an emergency SMS over the IMS session.

4. The method according to claim 3, further comprising
transmitting a session initiation protocol OK message to the UE, accepting the IMS session.

5. A method performed by a IP Short Message Gateway, IP-SM-GW, for handling messaging of a user equipment, UE, in a communication network, the method comprising:
establishing an Internet Protocol Multimedia Subsystem, IMS, session targeted to a Public Safety Access Point, PSAP; and
sending an emergency SMS over the IMS session.

6. The method according to claim 5, further comprising:
receiving a 202 accepted from the PSAP.

7-10. (canceled)

11. An IP Short Message Gateway, IP-SM-GW, for handling messaging of a user equipment, UE, in a communication network, wherein the IP-SM-GW is configured to:
establish an Internet Protocol Multimedia Subsystem, IMS, session targeted to a Public Safety Access Point, PSAP; and
send an emergency SMS over the IMS session.

12. The IP-SM-GW according to claim 11, wherein the IP-SM-GW is further configured to:
receive a 202 accepted from the PSAP.
